(19) United States
(12) Patent Application Publication
(10) Pub. No.: US 2015/0317645 A1
(43) Pub. Date: Nov. 5, 2015

(54) LEAD-BASED ACTIVATION OF M2M DEVICES ON AN OPERATOR NETWORK

(71) Applicant: Verizon Patent and Licensing Inc., Basking Ridge, NJ (US)

(72) Inventor: Abhijit KUDRIMOTI, San Diego, CA (US)

(73) Assignee: Verizon Patent and Licensing Inc., Basking Ridge, NJ (US)

(21) Appl. No.: 14/265,517

(22) Filed: Apr. 30, 2014

(51) Int. Cl. G06Q 30/02; G06Q 50/30; G06Q 10/00

(52) U.S. Cl. CPC G06Q 30/0201; G06Q 10/00; G06Q 50/30

(57) ABSTRACT

Devices may receive lead information from a user. The lead information may indicate a potential customer for a vendor. The devices may receive a user identifier that identifies the user. The devices may generate a lead identifier that identifies the lead information and associate the lead information, the user identifier, and the lead identifier. The devices may provide the lead information and the lead identifier to a vendor. The devices may receive an activation request and the lead identifier from the vendor. The devices may activate a particular device to communicate via the operator network based on the activation request. The device may determine the user identifier associated with the lead identifier. The devices may cause the user, identified by the user identifier, to be compensated based on the particular device being activated to communicate via the operator network.

### BACKGROUND

A vendor may provide machine-to-machine (M2M) devices, which wirelessly connect to an operator network (e.g., a cellular network, a long term evolution (LTE) network, etc.), to customers. For example, the vendor may be a vertical market vendor that offers goods or services to customers with specialized needs. The vendors may pay an operator of the operator network to activate and use the M2M devices on the operator network.

### BRIEF DESCRIPTION OF THE DRAWINGS

FIGS. 1A and 1B are diagrams of an overview of an example implementation described herein;

FIG. 2 is a diagram of an example environment in which systems and/or methods, described herein, may be implemented;

FIG. 3 is a diagram of example components of one or more devices of FIG. 2;

FIG. 4 is a flow chart of an example process for receiving a lead from a sales person and providing the lead to a vendor;

FIG. 5 is a flow chart of an example process for compensating a sales person for a vendor activating a M2M device based on a lead provided by the sales person; and

FIGS. 6A-6C are diagrams of an example implementation relating to the example processes shown in FIGS. 4 and 5.

### DETAILED DESCRIPTION OF PREFERRED EMBODIMENTS

The following detailed description of example implementations refers to the accompanying drawings. The same reference numbers in different drawings may identify the same or similar elements.

A sales person employed by an operator of an operator network may obtain a lead for a potential customer of a vendor that provides M2M devices. Accordingly, it may be in the best interest of the operator of the operator network to provide a lead management platform that allows the sales person to easily provide the lead to the vendor. An operator network may already provide a platform that allows a vendor to request activation of M2M devices, a platform that activates M2M devices, a platform that bills vendors for activating M2M devices, and a platform for paying employees. However, if the lead management platform is not integrated with these other platforms, properly compensating the sales person for the lead may become cumbersome for the vendor and the operator of the operator network.

For example, if the lead management platform is not integrated with the other platforms, the vendor may be required to email spreadsheets to the operator indicating a lead used to activate a M2M device, and then the operator may be required to track down a sales representative that provided the lead. Moreover, this process may not ensure the sales person is properly compensated. For example, the vendor may intentionally or unintentionally give credit for referring the lead to a wrong sales person. Additionally, or alternatively, if sales people are assigned geographic sales territories, the operator may only compensate a sales person for M2M devices activated in the sales person's geographic sales territory, even if the lead resulted in M2M devices being activated outside the sales person's geographic sales territory.

Implementations described herein may allow a lead obtained by a sales person to be anonymously provided to a vendor and for the sales person to be compensated for the vendor activating M2M devices based on the lead. Furthermore, a process of compensating the sales person may be integrated into a process for activating a M2M device. Additionally, or alternatively, implementations described hereon may compensate the sales person independently of a geographic sales territory assigned to the sales person.

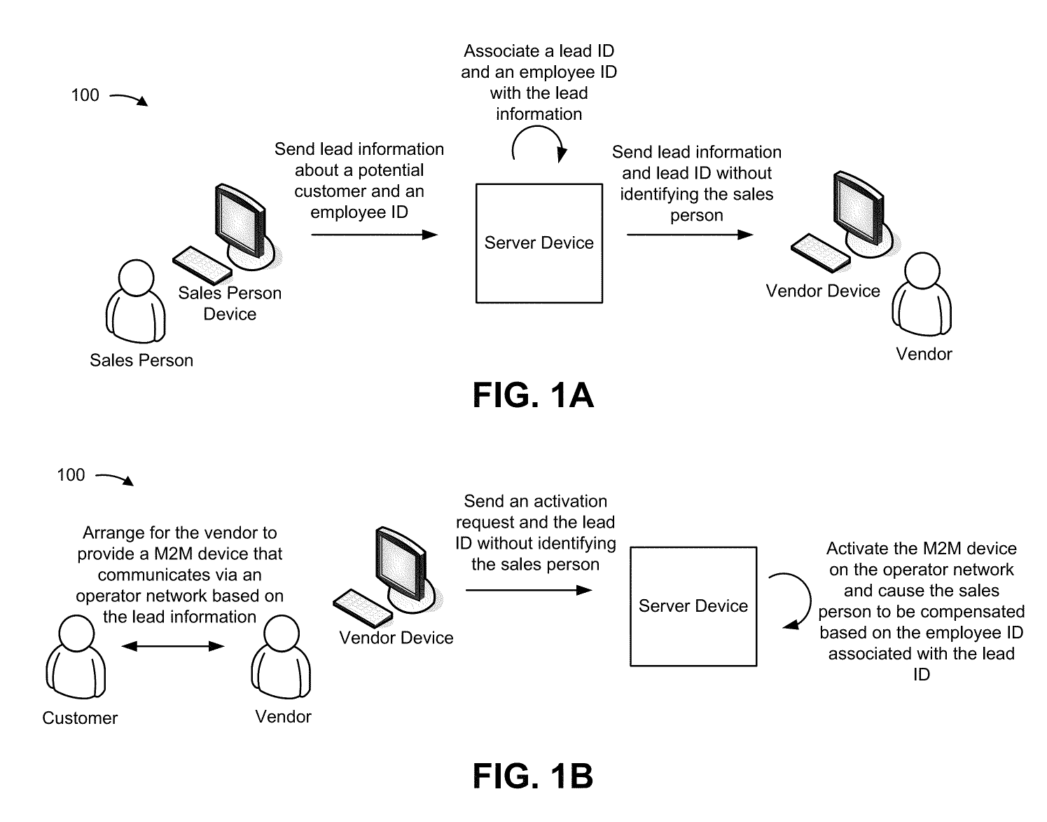

FIGS. 1A and 1B are diagrams of an overview of an example implementation 100 described herein. In FIG. 1A, assume a vendor provides M2M devices that connect to the operator network. Further, assume a sales person, employed by an operator of the operator network, obtains a lead about a customer that may be interested in a service and/or a product provided by the vendor.

Assume the sales person inputs lead information identifying the lead and an employee identifier (ID) identifying the sales person into a sales person device. In some implementations, the sales person may input the information identifying a vendor that may be interested in the lead. The sales person device may send the lead information, the employee ID, and/or information identifying the vendor to a server device operated by the operator of the operator network.

The server device may receive the lead information, the employee ID, and/or information identifying the vendor. The server device may generate a lead ID for the lead information and store the lead information, the lead ID, and the employee ID as an entry in a lead data structure, such that the lead information, the lead ID, and the employee ID are associated with one another. The server device may send the lead ID and the lead information to a vendor device used by the vendor identified by the sales person. However, the server device may not send any information identifying the sales person to the vendor device. The vendor device may receive the lead information and the lead ID, and may present the lead ID and the lead information to the vendor.

As shown in FIG. 1B, the vendor may contact the customer identified by the lead information and arrange for the vendor to provide one or more M2M devices, which communicate via the operator network, to the customer. The vendor may use the vendor device to send an activation request, which requests that the M2M devices be activated on the operator network, and the lead ID to the server device.

The server device may receive the activation request and the lead ID. The server device may activate the M2M devices based on the activation request. Furthermore, the server device may determine an employee ID associated with the lead ID and compensate the sales person associated with the employee ID.

In this way, the sales person may provide a lead to a vendor while keeping the sales person's identity anonymous from the vendor. Moreover, the sales person may be compensated when the vendor uses the lead to activate M2M devices on the operator network and may be compensated independent of any geographic sales territory assigned to the sales person.

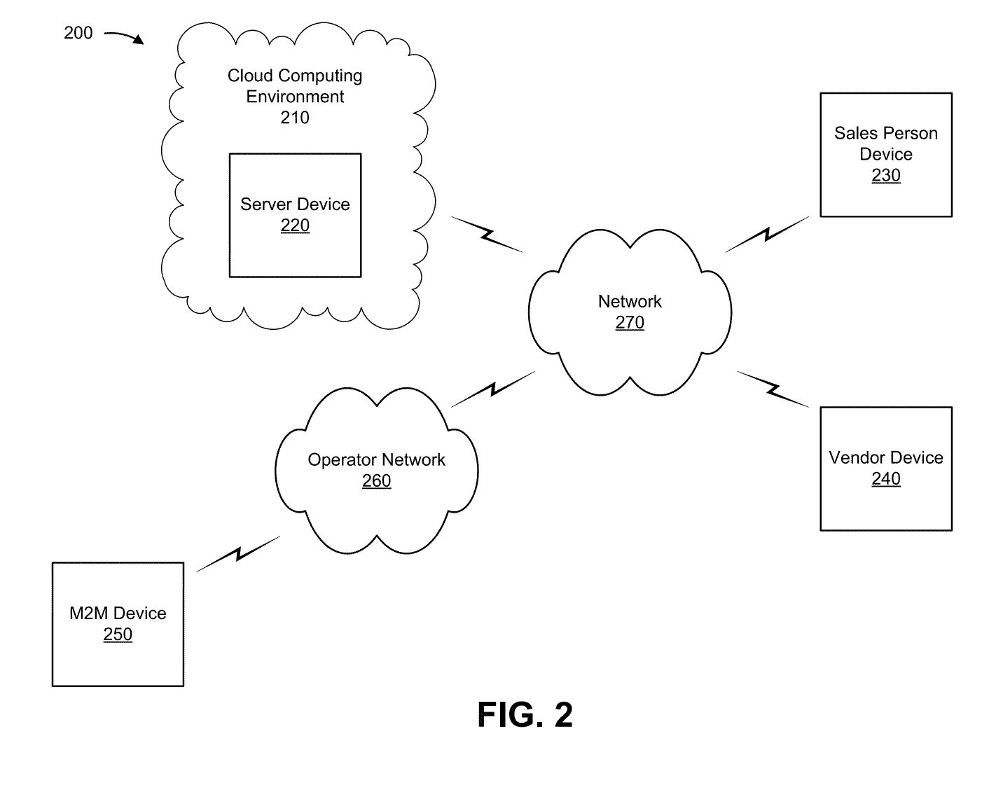

FIG. 2 is a diagram of an example environment 200 in which systems and/or methods, described herein, may be implemented. As shown in FIG. 2, environment 200 may include a cloud computing environment 210, a server device 220, a sales person device 230, a vendor device 240, a M2M device 250, an operator network 260, and/or a network 270. Devices of environment 200 may interconnect via wired connections, wireless connections, or a combination of wired and wireless connections.

Cloud computing environment 210 may include an environment that delivers computing as a service, whereby shared resources, services, etc. may be provided to sales person device 230, vendor device 240, and/or M2M device 250. Cloud computing environment 210 may provide computation, software, data access, storage, and/or other services that do not require end-user knowledge of a physical location and configuration of a system and/or a device that delivers the services. As shown, cloud computing environment 210 may include server device 220. In practice, cloud computing environment 210 may include multiple server devices 220 that communicate with one another. Cloud computing environment 210 may be operated by an operator of operator network 260.

Server device 220 may include one or more devices capable of storing, processing, and/or routing information. In some implementations, server device 220 may include a communication interface that allows server device 220 to receive information from and/or transmit information to other devices in environment 200. One or more server devices 220 in cloud computing environment 210 may operate a lead management platform that allows a sales person to upload lead information and that allows the lead information to be distributed to vendors. One or more server devices 220 included in cloud computing environment 210 may operate a Unified Web Service (UWS) that a vendor may use to request activation of M2M device 250. The UWS may be an enterprise web service for M2M relevant services (such as device activations, lead information retrievals, etc.). Furthermore, one or more server devices 220 included in cloud computing environment 210 may operate an activation platform for activating M2M device 250 for use on operator network 260, for billing vendors for the use of M2M device 250 on operator network 260, and for compensating a sales person. The lead management platform, the UWS, and/or the activation platform may be operated by the same or different server devices 220 within cloud computing environment 210. While server device 220 is shown as being included in cloud computing environment 210, in some implementations, server device 220 may be operated independently of cloud computing environment 210.

Sales person device 230 may include a device capable of receiving, processing, and/or providing information. For example, sales person device 230 may include a mobile phone (e.g., a smart phone, a radiotelephone, etc.), a computing device (e.g., a desktop computer, a laptop computer, a tablet computer, a handheld computer, etc.), or a similar device. In some implementations, sales person device 230 may include a communication interface that allows sales person device 230 to receive information from and/or transmit information to another device in environment 200. Sales person device 230 may be operated by a sales person.

Vendor device 240 may include a device capable of receiving, processing, and/or providing information. For example, vendor device 240 may include a mobile phone (e.g., a smart phone, a radiotelephone, etc.), a computing device (e.g., a desktop computer, a laptop computer, a tablet computer, a handheld computer, etc.), or a similar device. In some implementations, vendor device 240 may include a communication interface that allows vendor device 240 to receive information from and/or transmit information to another device in environment 200. Vendor device 240 may be operated by a vendor.

M2M device 250 may include a device capable of receiving, processing, and/or providing information over operating network 260. For example, M2M device 250 may include a network device (e.g., a modem, a switch, a gateway, etc.), a sensing device, a processing device, and/or some other type of device. In some implementations, M2M device 250 may include a sensing or metering device to gather data (e.g., temperature measurements, resource usage measurements, motion detection, object detection, etc.), a processing device to process the data to form processed data, a vending machine, a security system, a camera, a banking device, and/or another kind of network device. In some implementations, M2M device 250 may include a communication interface that allows M2M device 250 to receive information from and/or transmit information to another device in environment 200. A vendor may provide M2M device 250 to a customer for use and server device 220 may activate M2M device 250 to use operator network 260 to connect to network 270.

Operator network 260 may include an evolved packet system (EPS) that includes a LTE network and/or an evolved packet core (EPC) that operate based on a third generation vendorship project (3GPP) wireless communication standard. The LTE network may be a radio access network (RAN) that includes one or more base stations, such as eNodeBs (eNBs), via which client devices (e.g., smart phones, tablet computers, machine-to-machine (M2M) devices, etc.) communicate with the EPC. The EPC may include a serving gateway (SGW), a mobility management entity device (MME), and/or a packet data network gateway (PGW) that enables devices to communicate with network 270 and/or an Internet protocol (IP) multimedia subsystem (IMS) core. The IMS core may include a home subscriber server (HSS)/authentication, authorization, accounting (AAA) server and/or a call session control function (CSCF) server and may manage certain information and services, such as authentication, session initiation, account information, and/or a user profile, associated with the client devices. The LTE network may include multiple base stations, and the EPC may include multiple SGWs, MMEs, and/or PGWs. Additionally, or alternatively, operator network 260 may include a cellular network, a public land mobile network (PLMN), a second generation (2G) network, a third generation (3G) network, a fourth generation (4G) network, a fifth generation (5G) network, and/or a similar type of network.

Network 270 may include one or more wired and/or wireless networks. For example, network 270 may include a cellular network, a PLMN, a 2G network, a 3G network, a 4G network, a 5G network, a LTE network, and/or a similar type of network. Additionally, or alternatively, network 270 may include a local area network (LAN), a wide area network (WAN), a metropolitan area network (MAN), a telephone network (e.g., the Public Switched Telephone Network (PSTN)), an ad hoc network, an intranet, the Internet, a fiber optic-based network, a satellite network, a cloud computing network, and/or a combination of these or other types of networks.

The number and arrangement of devices and networks shown in FIG. 2 is provided as an example. In practice, there may be additional devices and/or networks, fewer devices and/or networks, different devices and/or networks, or differently arranged devices and/or networks than those shown in FIG. 2. For example, cloud computing environment 210, sales person device 230, and/or vendor device 240 may communicate with network 270 via operator network 260. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

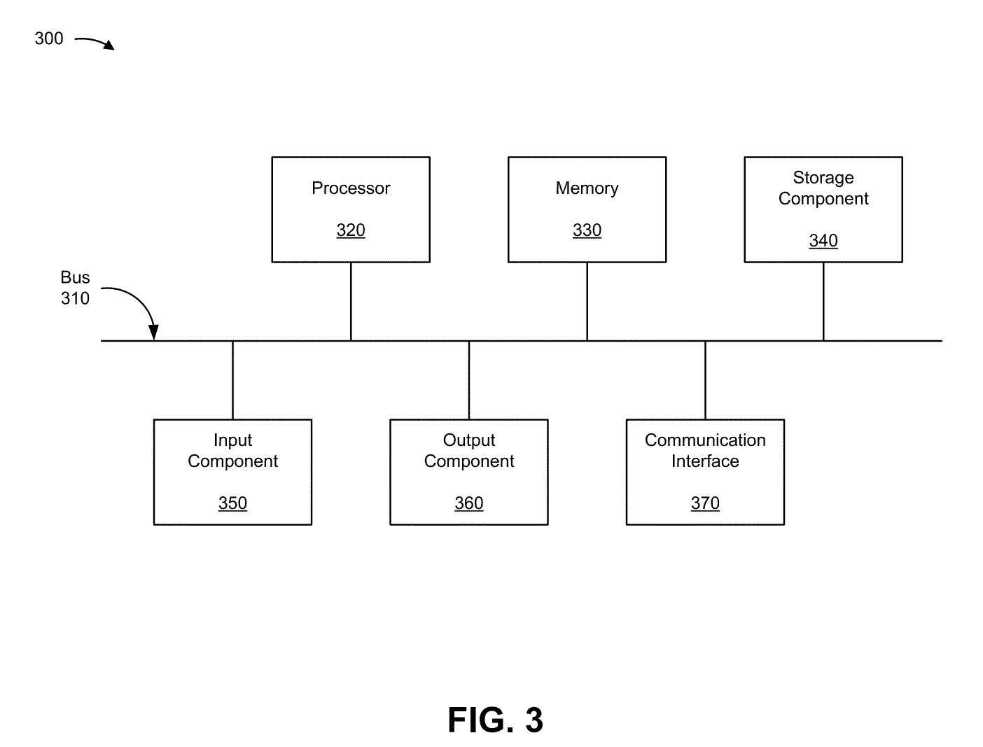

FIG. 3 is a diagram of example components of a device 300. Device 300 may correspond to server device 220, sales person device 230, vendor device 240, and/or M2M device 250. In some implementations, server device 220, sales person device 230, vendor device 240, and/or M2M device 250 may include one or more devices 300 and/or one or more components of device 300. As shown in FIG. 3, device 300 may include a bus 310, a processor 320, a memory 330, a storage component 340, an input component 350, an output component 360, and a communication interface 370.

Bus 310 may include a component that permits communication among the components of device 300. Processor 320 may include a processor (e.g., a central processing unit (CPU), a graphics processing unit (GPU), an accelerated processing unit (APU), etc.), a microprocessor, and/or any processing component (e.g., a field-programmable gate array (FPGA), an application-specific integrated circuit (ASIC), etc.) that interprets and/or executes instructions. Memory 330 may include a random access memory (RAM), a read only memory (ROM), and/or another type of dynamic or static storage device (e.g., a flash memory, a magnetic memory, an optical memory, etc.) that stores information and/or instructions for use by processor 320.

Storage component 340 may store information and/or software related to the operation and use of device 300. For example, storage component 340 may include a hard disk (e.g., a magnetic disk, an optical disk, a magneto-optic disk, a solid state disk, etc.), a compact disc (CD), a digital versatile disc (DVD), a floppy disk, a cartridge, a magnetic tape, and/or another type of computer-readable medium, along with a corresponding drive.

Input component 350 may include a component that permits device 300 to receive information, such as via user input (e.g., a touch screen display, a keyboard, a keypad, a mouse, a button, a switch, a microphone, etc.). Additionally, or alternatively, input component 350 may include a sensor for sensing information (e.g., a global positioning system (GPS) component, an accelerometer, a gyroscope, an actuator, etc.). Output component 360 may include a component that provides output information from device 300 (e.g., a display, a speaker, one or more light-emitting diodes (LEDs), etc.).

Communication interface 370 may include a transceiver-like component (e.g., a transceiver, a separate receiver and transmitter, etc.) that enables device 300 to communicate with other devices, such as via a wired connection, a wireless connection, or a combination of wired and wireless connections. Communication interface 370 may permit device 300 to receive information from another device and/or provide information to another device. For example, communication interface 370 may include an Ethernet interface, an optical interface, a coaxial interface, an infrared interface, a radio frequency (RF) interface, a universal serial bus (USB) interface, a Wi-Fi interface, a cellular network interface, or the like.

Device 300 may perform one or more processes described herein. Device 300 may perform these processes in response to processor 320 executing software instructions stored by a computer-readable medium, such as memory 330 and/or storage component 340. A computer-readable medium is defined herein as a non-transitory memory device. A memory device includes memory space within a single physical storage device or memory space spread across multiple physical storage devices.

Software instructions may be read into memory 330 and/or storage component 340 from another computer-readable medium or from another device via communication interface 370. When executed, software instructions stored in memory 330 and/or storage component 340 may cause processor 320 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 3 is provided as an example. In practice, device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

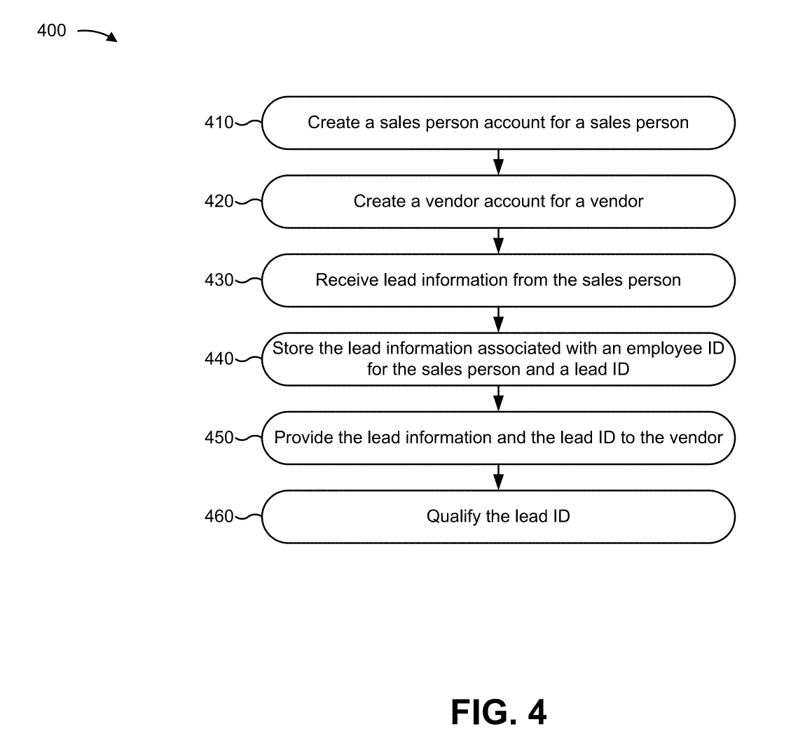

FIG. 4 is a flow chart of an example process 400 for receiving a lead from a sales person and providing the lead to a vendor. In some implementations, one or more process blocks of FIG. 4 may be performed by cloud computing environment 210 and/or server device 220. In some implementations, one or more process blocks of FIG. 4 may be performed by another device or a group of devices separate from or including cloud computing environment 210 and/or server device 220, such as sales person device 230, vendor device 240, and/or M2M device 250.

As shown in FIG. 4, process 400 may include creating a sales person account for a sales person (block 410). For example, server device 220 may create the sales person account for the sales person.

A sales person may use sales person device 230 to send a request to create a sales person account to server device 220. The sales person, via sales person device 230, may send account information specifying login information for logging into the account (e.g., a username, a password, biometric information, etc.), contact information, a sales person name, and/or an employee ID. An employee ID may be a string of characters of any length that is uniquely associated with a sales person.

Server device 220 may receive the request and the account information. Server device 220 may create the sales person account based on the request by creating an entry for the sales person account in an account data structure stored in a memory of server device 220 and/or a memory accessible by server device 220 (e.g., a memory included in cloud computing environment 210). The sales person account (e.g., the entry) may associate the login information, the employee name, and the employee ID. A sales person may use the sales person account to provide information about leads to vendors using the lead management platform.

Server device 220 may create multiple sales person accounts for multiple sales people and may generate a respective entry in the account data structure for each sales person account.

As further shown in FIG. 4, process 400 may include creating a vendor account for a vendor (block 420). For example, server device 220 may create the vendor account for the vendor.

A vendor may use vendor device 240 to send a request to create a vendor account to server device 220. The vendor, via vendor device 240, may send account information specifying login information for logging into the account (e.g., a username, a password, biometric information, etc.), a vendor name, and/or contact information.

Server device 220 may receive the request and the account information. Server device 220 may create the vendor account based on the request by creating an entry for the vendor account in an account data structure stored in a memory of server device 220 and/or a memory accessible by server device 220 (e.g., a memory included in cloud computing environment 210). The vendor account (e.g., the entry) may associate the login information, the vendor name, and/or the contact information. A vendor may use the vendor account to receive information about leads from a sales person using the lead management platform and to send activation requests using the UWS.

Server device 220 may create multiple vendor accounts for multiple vendors and may generate a respective entry in the account data structure for each vendor account.

As further shown in FIG. 4, process 400 may include receiving lead information from a sales person (block 430). For example, server device 220 may receive the lead information from the sales person via sales person device 230.

A sales person may become aware of a potential customer that has a need for a service and/or a product provided by a vendor. In other words, the sales person may have a lead for a vendor on a potential customer. The sales person may log into the sales person account by inputting the login information for the sales person account into sales person device 230. Sales person device 230 may send the login information to server device 220. Server device 220 may receive the login information and authenticate that the received login information matches the login information associated with the sales person account. Server device 220 may allow the sales person, via sales person device 230, to access the lead management platform upon a successful login.

In some implementations, server device 220 may provide sales person device 230 a lead management application programing interface (API) for communicating with the lead management platform. In some implementations, the lead management API may include fields for lead information, vendor information, and/or an employee ID.

The sales person may input lead information into sales person device 230. The lead information may indicate a customer name, a location of the customer, contact information for the customer, and/or a product and/or a service needed by the customer. In some implementations, the sales person may input a vendor name of a vendor that may be interested in the lead information and to which the sales person desires to send the lead information. Additionally, or alternatively, the sales person may input an employee ID into sales person device 230 that uniquely identifies the sales person. In some implementations, the sales person may input employee IDs for other sales people that contributed to the lead. Sales person device 230 may send the lead information, the vendor name, and/or the employee ID to server device 220 via the lead management API.

Server device 220 may receive the lead information, the vendor name, and/or the employee ID from sales person device 230 via the lead management API. In some implementations, rather than receiving the employee ID from sales person device 230, server device 220 may obtain the employee ID from the sales person account that the sales person logged into to send the lead information.

As further shown in FIG. 4, process 400 may include storing the lead information associated with the employee ID for the sales person and a lead ID (block 440). For example, server device 220 may store the lead information, the employee ID, and the lead ID.

Server device 220 may generate a lead ID that uniquely identifies the lead information. Server device 220 may store the lead information, the employee ID, and/or the lead ID as an entry in a lead data structure stored in a memory of server device 220 and/or a memory accessible by server device 220 (e.g., a memory included in cloud computing environment 210). The entry may associate the lead information, the employee ID, and/or the lead ID. In some implementations, the lead data structure may be managed by the lead management platform.

As further shown in FIG. 4, process 400 may include providing the lead information and the lead ID to a vendor (block 450). For example, server device 220 may provide the lead information and the lead ID to the vendor.

In some implementations, server device 220 may provide the lead information to the vendor associated with the vendor name provided by the sales person. In other words, if the sales person input a name of a vendor that may be interested in the lead information, server device 220 may provide the lead information to that vendor when the vendor logs into the vendor account. For example, the vendor may log into the vendor account using vendor device 240 to access the lead management platform and be provided with the lead information via the lead management API. Server device 220 may provide the lead information and the lead ID to the vendor device 240 that the vendor used to log into the vendor account. Additionally, or alternatively, server device 220 may send a notification that lead information is available and/or the lead information to the vendor using the contact information included in the vendor account. For example, server device 220 may send a notification via email, text message, instant message, etc. to the vendor and the vendor may log into the vendor account to receive the lead information.

Additionally, or alternatively, a vendor may log into a vendor account and search the lead data structure for lead information. For example, vendor device 240 may send a search query to server device 220. Server device 220 may receive the search query, and search the lead data structure for lead information associated with the search query. Server device 220 may provide any lead information associated with the search query to vendor device 240 for the vendor to use. Accordingly, even if a sales person does not know of a specific vendor that may be interested in the lead information, the sales person may upload the lead information to server device 220 for vendors to search.

Vendor device 240 may receive the lead information and the lead ID from server device 220. Vendor device 240 may present the lead information and the lead ID to the vendor.

As further shown in FIG. 4, process 400 may qualify a lead ID (block 460). For example, server device 220 may qualify a lead ID.

The vendor may not be interested in pursuing all the leads (e.g., lead information) provided to the vendor from one or more sales persons. For example, the lead information may be related to a product or service that the vendor cannot fulfill. Accordingly, server device 220 may send vendor device 240 a request to qualify or choose one or more lead IDs the vendor is interested in pursuing. The vendor may input a selection into vendor device 240 of one or more lead IDs associated with lead information the vendor desires to pursue. Vendor device 240 may send the selected lead ID to server device 220 via the lead management API.

Server device 220 may receive the selected ID and store information indicating the selected ID is a qualified lead ID in the lead data structure.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

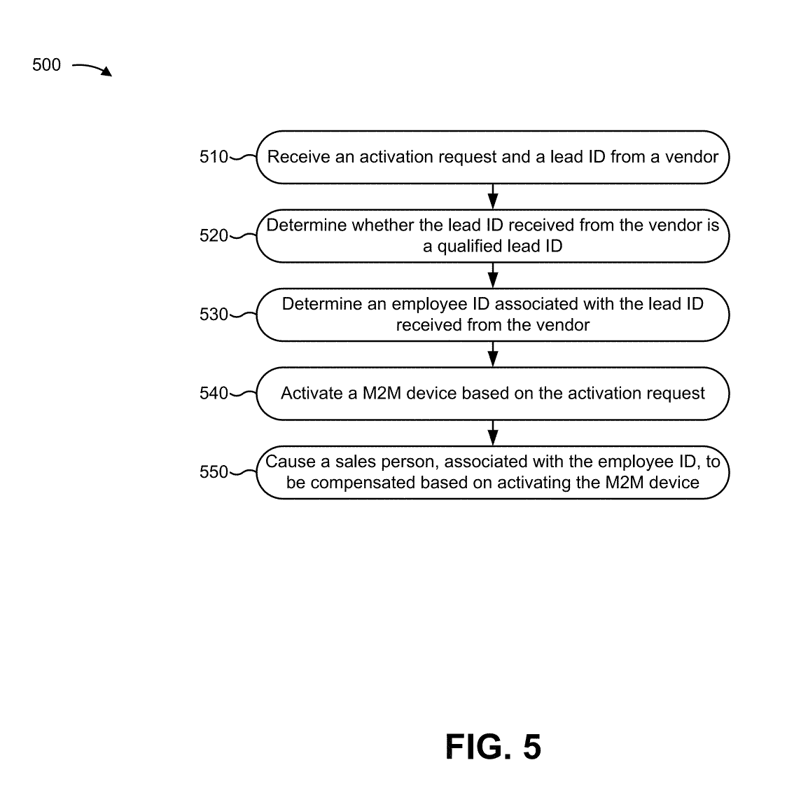

FIG. 5 is a flow chart of an example process 500 for compensating a sales person for a vendor activating a M2M device 250 based on a lead provided by the sales person. In some implementations, one or more process blocks of FIG. 5 may be performed by cloud computing environment 210 and/or server device 220. In some implementations, one or more process blocks of FIG. 5 may be performed by another device or a group of devices separate from or including cloud computing environment 210 and/or server device 220, such as sales person device 230, vendor device 240, and/or M2M device 250.

As shown in FIG. 5, process 500 may include receiving an activation request and the lead ID from the vendor (block 510). For example, server device 220 may receive the activation request and the lead ID from the vendor.

The vendor may use the lead information obtained at block 450 in FIG. 4 to contact the customer and arrange for the vendor to provide a product and/or a service for the customer. For example, the vendor may arrange to provide the customer with a M2M device 250 that uses operator network 260 to connect to network 270. In some implementations, the vendor may manage M2M device 250 for the customer. Before the vendor can provide M2M device 250 for use, the vendor may need to activate M2M device 250 for use on operator network 260.

Accordingly, the vendor may use vendor device 240 to send an activation request to server device 220 to activate M2M device 250 using the UWS. Vendor device 240 may prompt the vendor to input a lead ID associated with the lead information used by the vendor to contact the customer. The vendor may input the vendor ID into vendor device 240 and use vendor device 240 to send the lead ID to server device 220. Server device 220 may receive the activation request and the lead ID from vendor device 240.

In some implementations, server device 220 may provide vendor device 240 a UWS API for communicating with the UWS. The UWS API may be software made available, in a generic standard language (e.g., Web Services Description Language), to a vendor via a software development kit (SDK). The UWS API may include fields for a lead ID and for an activation request.

The activation request may include a request to activate one or more M2M devices 250 for use on operator network 260. The activation request may include a M2M device ID that uniquely identifies the M2M device 250 to be activated. In some implementations, the UWS API may include a field for a M2M device ID.

In some implementations, the activation request may include location information identifying a location where M2M device 250 will be used. For example, the location information may include a service postal code for a location from which M2M device 250 will access operator network 260. The location identified by the location information (e.g., the service postal code) may be different than a postal code for the customer (e.g., a postal code included in the customer contact information) associated with the lead information. For example, the customer may request that the vendor provide M2M device 250 for use outside of where the customer is headquartered. In some implementations, the UWS API may include a location information field.

Additionally, or alternatively, the activation request may include service plan information. For example, the service plan information may indicate a quantity of data, text messages, and/or call minutes that M2M device 250 is permitted to use for a particular amount of time (e.g., per day, month, year, etc.). Additionally, or alternatively, the service plan information may indicate a cost associated with using data, text messages, and/or call minutes. In some implementations, the UWS API may include a service plan information field.

As further shown in FIG. 5, process 500 may include determining whether the lead ID received from the vendor is a qualified lead ID (block 520). For example, server device 220 may determine whether the lead ID is associated with qualified lead information.

In some implementations, server device 220 may use the UWS to obtain qualified lead IDs, lead information associated with the qualified lead IDs, and employee IDs associated with the qualified lead IDs from the lead management platform. For example, the lead management platform (or a server 220 operating the lead management platform) may allow the UWS (or a server 220 operating the UWS) to access the lead data structure.

Server device 220 may check whether the lead ID received from the vendor matches any of the qualified lead IDs. If the received lead ID matches a qualified lead ID, server device 220 may determine that the received ID is a qualified lead ID. If the received lead ID does not match a qualified lead ID, server device 220 may not determine that the received ID is a qualified lead ID. In some implementations, server device 220 may only compensate a sales person if the lead ID is a qualified lead ID.

Additionally, or alternatively, server device 220 may provide, via the UWS API, a list of qualified lead IDs and/or lead information to vendor device 240 that were qualified by the vendor. Vendor device 240 may receive the list of qualified lead IDs and/or lead information and present the list to the vendor. For example, vendor device 240 may display a name of customer associated with the lead and/or the qualified lead ID. The vendor may input a selection of a qualified lead ID, associated with lead information related to the activation request, into vendor device 240 and vendor device 240 may send the qualified lead ID to server device 220. Server device 220 may receive the qualified lead ID from vendor device 240 that was selected by the vendor.

As further shown in FIG. 5, process 500 may include determining an employee ID associated with the lead ID received from the vendor (block 530). For example, server device 220 may determine the employee ID.

Server device 220 may, via the UWS, determine the employee ID associated with the lead ID received from the vendor based on the associated lead ID and employee ID received from the lead management platform.

As further shown in FIG. 5, process 500 may include activating M2M device 250 based on the activation request (block 540). For example, server device 220 may activate M2M device 250 for use on operator network 260.

In some implementations, the UWS may send the activation request and the employee ID to the activation platform operated by server device 220. Server device 220 may use the activation platform to activate M2M device 250.

Server device 220 may activate M2M device 250 by adding the M2M device ID for M2M device 250 to a list of M2M device IDs authorized to access operator network 260. In some implementations, server device 220 may activate M2M device 250 by assigning a mobile directory number (MDN) to M2M device 250. For example, server device 220 may generate a MDN for M2M device 250 based on the service postal code for M2M device 250. Additionally, or alternatively, server device 220 may instruct a network device included in operator network 260 to permit M2M device 250 to connect to operator network 260.

Server device 220 may use the activation platform to provide an activation confirmation to vendor device 240, via the UWS API, indicating that M2M device 250 has been activated and/or indicating the MDN for M2M device 250.

As further shown in FIG. 5, process 500 may include causing a sales person, associated with the employee ID, to be compensated based on activating the M2M device 250 (block 550). For example, server device 220 may cause the sales person to be compensated.

Server device 220 may identify the sales person associated with the employee ID and cause the sales person to be compensated for M2M device 250 being activated based on the lead information provided by the sales person. For example, the sales person may receive monetary compensation as determined by the activation platform. Additionally, or alternatively, the sales person may be compensated with another form of compensation. The sales person may be compensated based on the number of M2M devices 250 activated, the service postal code of an activated M2M device 250, and/or the service plan associated with an activated M2M device 250. In some implementations, the sales person may be compensated independent of the service postal code.

Accordingly, the lead management platform, the UWS, and the activation platform may work together to cause a sales person to be compensated based on a lead provided to a vendor via the lead management platform.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

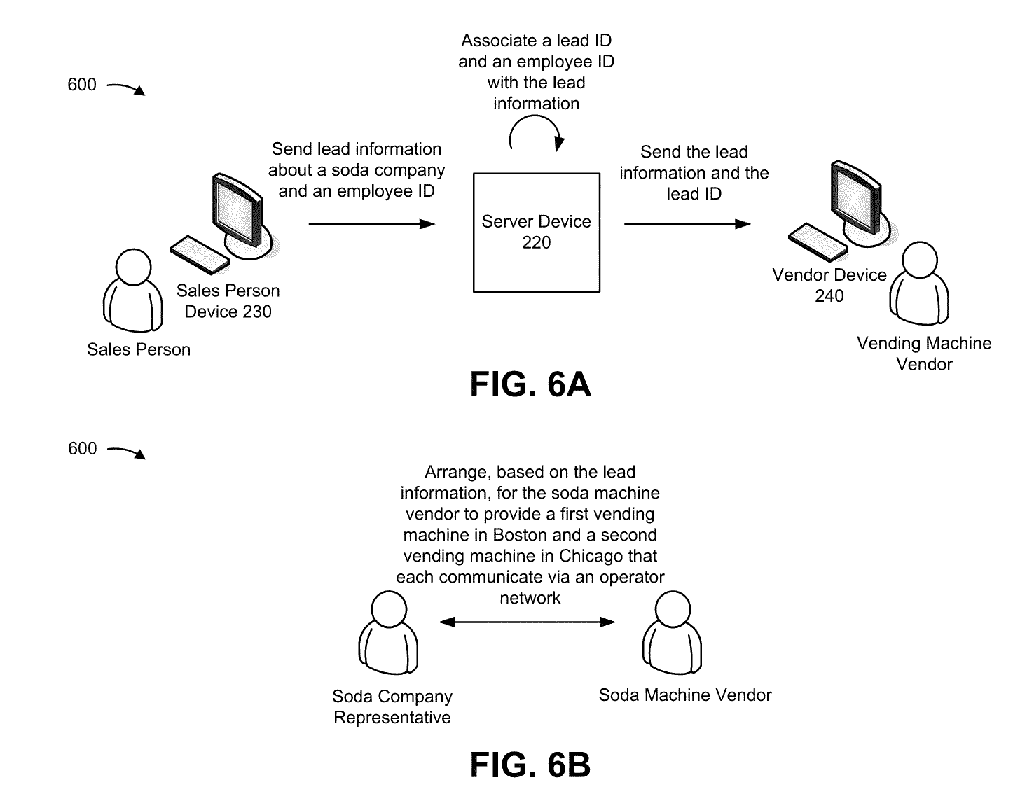

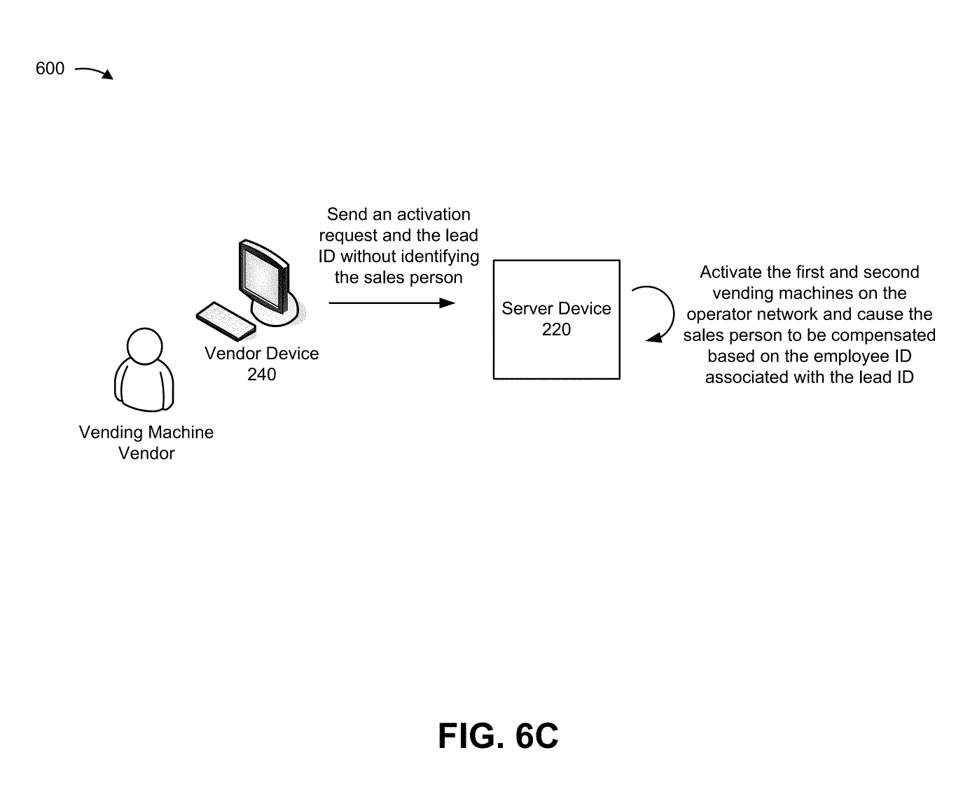

FIGS. 6A-6C are diagrams of an example implementation 600 relating to example process 400 shown in FIG. 4 and example process 500 shown in FIG. 5. FIGS. 6A-6C show an example process of receiving a lead from a sales person, providing the lead to a vendor, and causing the sales person to be compensated for the vendor activating a M2M device 250 based on the lead.

In FIG. 6A, assume a sales person is employed by an operator of operator network 260. Further, assume the sales person obtains a lead that a soda company is looking for vending machines that are capable of wirelessly communicating the operational statues of the vending machines.

The sales person may input lead information about the lead into sales person device 230. For example, the lead information may include the name of the soda company, contact information for a soda company representative, and/or information on the vending machines the soda company wants. The sales person may also input an employee ID for the sales person and information identifying a vending machine vendor that may be interested in the lead into sales person device 230. Sales person device 230 may send the lead information, the employee ID, and the information identifying the vending machine vendor to server device 220.

Server device 220 may receive the lead information, the employee ID, and the information identifying the vending machine vendor from sales person device 230. Server device 220 may generate a lead ID for the lead information and store, in a memory, the lead information, the lead ID, and the employee ID such that the lead information, the lead ID, and the employee ID are associated with one another. Server device 220 may send the lead information and the associated lead ID to vendor device 240 operated by the vending machine vendor identified by the sales person.

Vendor device 240 may receive the lead information and the lead ID and present the lead information and the lead ID to the vending machine vendor.

As shown in FIG. 6B, the vending machine vendor may use the lead information to contact the soda company representative. The vending machine vendor and the soda company representative may arrange for the vending machine vendor to provide a first soda machine in Boston and a second vending machine in Chicago.

As shown in FIG. 6C, the vending machine vendor may use vendor device 240 to send an activation request and the lead ID to server device 220. However, the vending machine vendor may not identify the sales person who provided the lead. The activation request may include a first vending machine ID for a first vending machine and indicate that the first vending machine is to be used in Boston. Also, the activation request may include a second vending machine ID for a second vending machine and indicate that the second vending machine is to be used in Chicago.

Server device 220 may receive the activation request and the lead ID from vendor device 240. Server device 220 may activate the first vending machine and the second vending machine based on the first and second vending machines IDs and based on where the first and second vending machines will be used (i.e., Boston and Chicago, respectively). Server device 220 may identify the employee ID associated with the lead ID and cause the corresponding sales person to be compensated based on the first and second vending machines being activated.

Accordingly, the sales person may be compensated for providing the lead to the vending machine vendor while keeping the identity of the sales person anonymous from the vending machine vendor. Moreover, the sales person may be compensated for vending machines being activated in Boston and Chicago even if Boston and Chicago are outside of a geographic sales territory assigned to the sales person.

As indicated above, FIGS. 6A-6C are provided merely as an example. Other examples are possible and may differ from what was described with regard to FIGS. 6A-6C.

Implementations described herein may allow a lead obtained by a sales person to be anonymously provided to a vendor and for the sales person to be compensated for the vendor activating M2M devices based on the lead. Furthermore, a process of compensating the sales person may be integrated into a process for activating a M2M device. Additionally, or alternatively, implementations described herein may cause the sales person to be compensated independently of a geographic sales territory assigned to the sales person.

The foregoing disclosure provides illustration and description, but is not intended to be exhaustive or to limit the implementations to the precise form disclosed. Modifications and variations are possible in light of the above disclosure or may be acquired from practice of the implementations.

As used herein, the term component is intended to be broadly construed as hardware, firmware, and/or a combination of hardware and software.

Certain user interfaces have been described herein and/or shown in the figures. A user interface may include a graphical user interface, a non-graphical user interface, a text-based user interface, etc. A user interface may provide information for display. In some implementations, a user may interact with the information, such as by providing input via an input component of a device that provides the user interface for display. In some implementations, a user interface may be configurable by a device and/or a user (e.g., a user may change the size of the user interface, information provided via the user interface, a position of information provided via the user interface, etc.). Additionally, or alternatively, a user interface may be pre-configured to a standard configuration, a specific configuration based on a type of device on which the user interface is displayed, and/or a set of configurations based on capabilities and/or specifications associated with a device on which the user interface is displayed.

To the extent the aforementioned embodiments collect, store or employ personal information provided by individuals, it should be understood that such information shall be used in accordance with all applicable laws concerning protection of personal information. Additionally, the collection, storage and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware can be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items, and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. One or more devices, comprising:
one or more processors to:
receive lead information from a user,
the lead information indicating a potential customer for a vendor;
receive a user identifier that identifies the user;
generate a lead identifier that identifies the lead information;
associate the lead information, the user identifier, and the lead identifier;
provide the lead information and the lead identifier to the vendor;
receive an activation request and the lead identifier from the vendor,
the activation request including a request to activate a particular device to communicate via an operator network;
activate the particular device to communicate via the operator network based on the activation request;
determine the user identifier associated with the lead identifier; and
cause the user, identified by the user identifier, to be compensated based on the particular device being activated to communicate via the operator network.

2. The one or more devices of claim 1, where the one or more processors, when providing the lead information and the lead identifier to the vendor, are further to:
provide the lead information and the lead identifier to the vendor without identifying the user.

3. The one or more devices of claim 1, where the lead information includes contact information for the potential customer that the vendor can use to contact the potential customer.

4. The one or more devices of claim 1, where the one or more processors are further to:
receive, from a user device associated with the user, vendor information identifying the vendor; and
where the one or more processors, when providing the lead information and the lead identifier to the vendor, are further to provide the lead information and the lead identifier to the vendor based on the vendor information.

5. The one or more devices of claim 1, where the one or more processors, when providing the lead information and the lead identifier to the vendor, are further to:
receive a lead request, from a vendor device associated with the vendor, that requests lead information related to a search query provided by the vendor; and
provide the lead information to the vendor device based on the search query.

6. The one or more devices of claim 1, where the one or more processors, when associating the lead information, the user identifier, and the lead identifier, are further to:
store the lead information, the user identifier, and the lead identifier in a data structure in association with one another.

7. The one or more devices of claim 1, where the one or more processors, when causing the user identified by the user identifier to be compensated based on the particular device being activated to communicate via the operator network, are further to:
cause the user to be compensated independent of a first location of the user, a second location of the potential customer, and a third location of the vendor.

8. A computer-readable medium storing instructions, the instructions comprising:
one or more instructions that, when executed by one or more processors, cause the one or more processors to:
receive lead information from a sales person device operated by a sales person,
the lead information indicating a potential customer for a vendor;
receive an employee identifier that identifies the sales person,
the sales person being an employee of an operator of an operator network;
generate a lead identifier that identifies the lead information;
associate the lead information, the employee identifier, and the lead identifier;
provide the lead information and the lead identifier to a vendor device operated by the vendor without providing information identifying the sales person to the vendor device;
receive an activation request and the lead identifier from the vendor device,
the activation request including a request to activate a particular device for use on the operator network;
cause the particular device to be activated for use on the operator network based on the activation request;
determine the employee identifier associated with the lead identifier; and
cause the sales person identified by the employee identifier to be compensated based on the particular device being activated on the operator network.

9. The computer-readable medium of claim 8, where the one or more instructions, when executed by the one or more processors, further cause the one or more processors to:
receive a plurality of employee identifiers that identify a plurality of sales persons,
the plurality of employee identifiers including the employee identifier, and
the plurality sales persons including the sales person;
associate the plurality of employee identifiers with the lead information and the lead ID; and
cause the plurality of sales persons to be compensated based on the particular device being activated on the operator network.

10. The computer-readable medium of claim 8, where the activation request includes location information identifying a location of the particular device, and
where the one or more instructions, that cause the one or more processors to cause the particular device to be activated, further cause the one or more processors to:
cause the particular deice to be activated based on the location information.

11. The computer-readable medium of claim 10, where the one or more instructions, that cause the one or more processors to cause the sales person to be compensated, further cause the one or more processors to:
cause the sales person to be compensated independent of the location information.

12. The computer-readable medium of claim 8, where the one or more instructions, that associate the lead information, the lead identifier, and the employee identifier and that determine the employee ID, further cause the one or more processors to:
store the lead information, the lead identifier, and the employee identifier as an entry in a lead data structure; and
obtain the employee identifier from the lead data structure based on receiving the lead identifier from the vendor device.

13. The computer-readable medium of claim 12, where the one or more instructions, that cause the particular device to be activated, further cause the one or more processors to:
send the employee identifier with the activation request to an activation platform for activating the particular device.

14. The computer-readable medium of claim 8, where the activation request includes service plan information indicating a service plan associated with the particular device, and
where the one or more instructions, that cause the one or more processors to cause the sales person to be compensated, further cause the one or more processors to:
cause the sales person to be compensated based on the service plan associated with the particular device activated for use on the operator network.

15. A method, comprising:
receiving, by at least one device, lead information from a user,
the lead information indicating a potential customer for a vendor;
receiving, by the at least one device, a user identifier that identifies the user;
generating, by the at least one device, a lead identifier that identifies the lead information;
generating, by the at least one device, an entry in a data structure that associates the lead information, the user identifier, and the lead identifier;
providing, by the at least one device, the lead information and the lead identifier to the vendor;
receiving, by the at least one device, an activation request and the lead identifier from the vendor,
the activation request including a request to activate a machine-to-machine (M2M) device to connect to an operator network;
causing, by the at least one device, the M2M device to be activated to connect to the operator network based on the activation request;
determining, by the at least one device, the user identifier associated with the lead identifier; and
causing, by the at least one device, the user identified by the user identifier to be compensated based on the M2M device being activated to connect to the operator network.

16. The method of claim 15, further comprising:
receiving information from the vendor indicating that the vendor is interested in pursuing the potential customer identified by the lead information; and
storing the lead identifier associated with the lead information as a qualified lead identifier indicating that the vendor is interested in pursuing the potential customer.

17. The method of claim 16, further comprising:
providing the qualified lead identifier to the vendor based on receiving the activation request; and
receiving the lead identifier from the vendor includes receiving the qualified lead identifier based on the vendor selecting the qualified lead identifier.

18. The method of claim 15, further comprising:
providing an application programming interface to a user device operated by the user; and
receiving the lead information and the user identifier from the user device via the application programming interface.

19. The method of claim 15, further comprising:
providing an application programming interface to a vendor device operated by the vendor; and
receiving the activation request and the lead identifier from the vendor device via the application programming interface.

20. The method of claim 15, where providing the lead identifier and the lead information to the vendor includes providing the lead identifier and the lead information without information identifying the user.
